(19) United States
(12) Patent Application Publication
(10) Pub. No.: US 2015/0086907 A1
(43) Pub. Date: Mar. 26, 2015

(54) PHOTOSENSITIVE COMPOSITION FOR VOLUME HOLOGRAM RECORDING, VOLUME HOLOGRAM RECORDING MEDIUM USING SAME, METHOD FOR MANUFACTURING VOLUME HOLOGRAM RECORDING MEDIUM, AND HOLOGRAM RECORDING METHOD

(71) Applicant: DAICEL CORPORATION, Osaka-shi, Osaka (JP)

(72) Inventors: Tomoya Mizuta, Himeji-shi (JP); Hiroto Miyake, Himeji-shi (JP)

(73) Assignee: DAICEL CORPORATION, Osaka-shi, Osaka (JP)

(21) Appl. No.: 14/394,839

(22) PCT Filed: Apr. 2, 2013
(86) PCT No.: PCT/JP2013/060114

§ 371 Date: Oct. 16, 2014

(30) Foreign Application Priority Data
Apr. 23, 2012 (JP) 2012-098041
May 10, 2012 (JP) 2012-108834

(51) Int. Cl. G03H 1/02

(52) U.S. Cl. CPC G03H 1/0248; G03H 2001/0264
USPC 430/2

(57) ABSTRACT

Provided is a photosensitive composition for volume hologram recording capable of forming a volume hologram recording medium that less shrinks upon curing in hologram recording (in hologram formation) and resists cracking. The photosensitive composition for volume hologram recording contains an alicyclic epoxy compound (A) represented by Formula (I); a thermal acid generator (B); a radically polymerizable compound (C); a radical polymerization initiator (D); and at least one epoxy compound (E) selected from the group consisting of compounds represented by Formula (1), epoxidized fatty acid esters, and epoxidized conjugated diene polymers.

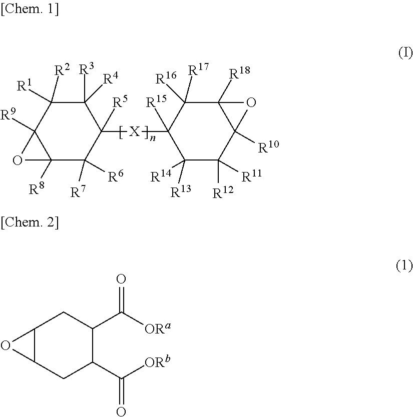

### TECHNICAL FIELD

The present invention relates to photosensitive compositions for volume hologram recording; volume hologram recording media obtained from the compositions; manufacturing methods of the recording media; and hologram recording methods using the volume hologram recording media.

### BACKGROUND ART

Holographic memories that make a record of information as a hologram are received attention as next-generation information recording media having large capacities and enabling high-speed transfer. Of hologram recording media, widely known are those having a recording layer (hologram recording layer) including a hologram recording photosensitive composition, where the photosensitive composition typically mainly includes a radically polymerizable monomer, a thermoplastic binder resin, a photo-radical polymerization initiator, and a sensitizing dye.

Information recording is performed by shaping the hologram recording photosensitive composition into a film; and subjecting the film to interference exposure. The radically polymerizable monomer is polymerized in a region irradiated with high-intensity light, and the radically polymerizable monomer diffuses or migrates from a region irradiated with low-intensity light to the region irradiated with high-intensity light to cause concentration gradient. This causes a difference in refractive index corresponding to the light intensity and thereby forms a hologram.

A conventionally proposed technology is a medium (hologram recording medium) that includes a three-dimensionally crosslinked epoxy matrix and a photopolymerizable monomer dispersed in the matrix. The medium of this type requires a certain hardness, but fails to have a sufficient difference in refractive index if the matrix is designed to have higher hardness. This is because such hard matrix fails to include sufficient free space where the photopolymerizable monomer can diffuse. In contrast, if the matrix is designed to have higher softness (flexibility) so as to include larger free space therein, the recording layer locally shrinks accompanied with the polymerization of the photopolymerizable monomer, and this disadvantageously impedes accurate reading (reproducing) of the recorded data.

A recording material having a three-dimensionally crosslinked matrix polymer using an ester-form alicyclic epoxy compound has been proposed (see typically Patent Literature (PTL) 1). Disadvantageously, the recording material is insufficient typically in water-vapor resistance and thermal stability, because the three-dimensionally crosslinked matrix polymer is formed from the ester-form alicyclic epoxy compound.

### CITATION LIST

### Patent Literature

PTL 1: Japanese Unexamined Patent Application Publication (JP-A) No. 2008-152170

### SUMMARY OF INVENTION

### Technical Problem

There is a thought in known volume hologram recording media that a polymer having a relatively rigid structure is employed as a polymer to form a matrix so as to help the matrix to less shrink upon curing in hologram recording (hologram formation). Unfortunately, this causes the hologram recording layer in the volume hologram recording medium to be hard and be susceptible to cracking. To prevent this, incorporation of an aliphatic dicarboxylic acid ester plasticizer into the volume hologram recording medium has been investigated so as to soften the hologram recording layer. The resulting hologram recording layer, however, has been found to suffer from cracking with time. Under the present circumstances as described above, a solution that enables both reduction in curing shrinkage during hologram recording and suppression of cracking (crack formation) in the hologram recording layer has not yet been obtained.

Accordingly, an object of the present invention is to provide a photosensitive composition for volume hologram recording capable of forming a volume hologram recording medium that less shrinks upon curing in hologram recording (in hologram formation) and resists cracking (particularly, cracking with time).

Another object of the present invention is to provide a volume hologram recording medium that less shrinks upon curing in hologram recording (in hologram formation) and resists cracking (particularly, cracking with time).

Yet another object of the present invention is to provide a method for manufacturing the volume hologram recording medium and a method for recording a hologram using the volume hologram recording medium.

### Solution to Problem

Specifically, the present invention provides a photosensitive composition for volume hologram recording, containing: an alicyclic epoxy compound (A) represented by Formula (I); a thermal acid generator (B); a radically polymerizable compound (C); a radical polymerization initiator (D); and at least one epoxy compound (E) selected from the group consisting of compounds represented by Formula (1), epoxidized fatty acid esters, and epoxidized conjugated diene polymers:

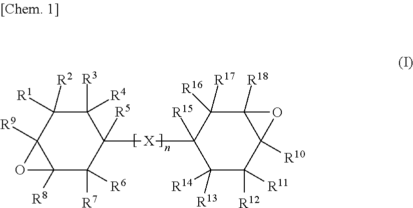

wherein n represents an integer from 0 to 10; X represents one divalent group selected from the group consisting of oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R¹⁸ are, identically or differently, selected from a hydrogen atom, a halogen atom, a hydrocarbon group optionally containing oxygen or halogen, or an optionally substituted alkoxy group;

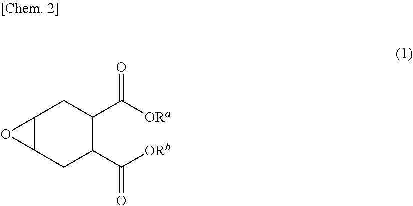

wherein R^{a} and R^{b} are independently selected from a monovalent linear or branched aliphatic hydrocarbon group; and a monovalent group corresponding to a linear or branched unsaturated aliphatic hydrocarbon group, except with part or all of carbon-carbon unsaturated bond(s) thereof being epoxidized.

The photosensitive composition for volume hologram recording may further contain a sensitizing dye.

The photosensitive composition for volume hologram recording may further contain at least one cationically polymerizable compound selected from the group consisting of epoxy compounds other than the alicyclic epoxy compound (A) and the epoxy compound (E); oxetane compounds; and vinyl ether compounds.

The photosensitive composition for volume hologram recording may contain the epoxy compound (E) in a content from 50 to 500 parts by weight per 100 parts by weight of the total amount of cationically polymerizable compound(s) other than the epoxy compound (E).

The present invention further provides a photosensitive composition for volume hologram recording obtained by a heat treatment of the photosensitive composition for volume hologram recording and containing: a three-dimensionally crosslinked polymer matrix; the radically polymerizable compound (C); and the radical polymerization initiator (D), where the matrix includes a cured product of cationically polymerizable compounds.

The present invention further provides a volume hologram recording medium containing a first substrate; a second substrate; and a volume hologram recording layer between the first and second substrates, where the layer includes the photosensitive composition for volume hologram recording.

The volume hologram recording medium may have a transmittance of 80% or more after recording and fixing of a hologram, where the recording of the hologram is performed by irradiating the volume hologram recording medium with a laser beam to polymerize the radically polymerizable compound (C) in the photosensitive composition for volume hologram recording.

The present invention further provides a method for manufacturing a volume hologram recording medium. The method includes the steps of holding the photosensitive composition for volume hologram recording between a first substrate and a second substrate to give a laminate; and subjecting the laminate to a heat treatment.

In addition and advantageously, the present invention provides a method for recording a hologram. The method includes the step of irradiating the volume hologram recording medium with an active energy ray to polymerize the radically polymerizable compound (C) in the photosensitive composition for volume hologram recording.

### Advantageous Effects of Invention

The photosensitive composition for volume hologram recording according to the present invention has the configuration, can thereby form a three-dimensionally crosslinked polymer matrix by a heat treatment, where the matrix includes a cured product of the cationically polymerizable compound and has at least a structural unit derived from the non-ester-form alicyclic epoxy compound (the alicyclic epoxy compound (A)). This allows the matrix to include larger free space therein while maintaining its rigidity (hardness) and contributes to excellent water-vapor resistance and thermal stability. In addition, the matrix also includes a structural unit derived from the specific epoxy compound (the epoxy compound (E)) and helps the hologram recording layer to resist cracking (particularly, cracking with time), because the epoxy compound (E) contributes to flexibility. Accordingly, the use of the photosensitive composition for volume hologram recording according to the present invention can provide a hologram recording medium and a hologram recording method using the same, which hologram recording medium has a high storage capacity and high refractive-index modulation and less changes in volume upon light irradiation.

### BRIEF DESCRIPTION OF DRAWINGS

FIG. 1 is a schematic diagram illustrating an optical system used for the determination of a diffraction efficiency and a shrinkage percentage in examples and comparative examples.

### DESCRIPTION OF EMBODIMENTS

### Photosensitive Composition for Volume Hologram Recording

A photosensitive composition for volume hologram recording according to an embodiment of the present invention essentially contains an alicyclic epoxy compound (A); a thermal acid generator (B); a radically polymerizable compound (C); a radical polymerization initiator (D); and an epoxy compound (E), where the alicyclic epoxy compound (A) refers to a non-ester alicyclic epoxy compound (A) represented by Formula (I), and the epoxy compound (E) refers to at least one epoxy compound selected from the group consisting of: compounds represented by Formula (1), epoxidized fatty acid esters, and epoxidized conjugated diene polymers:

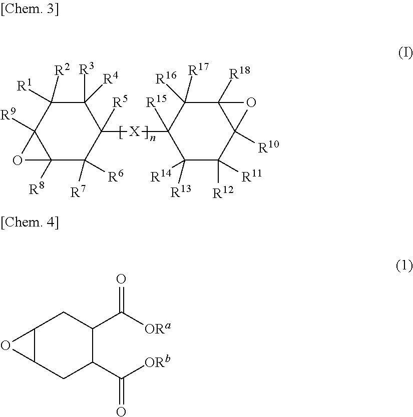

The photosensitive composition for volume hologram recording according to the present invention may further include a sensitizer (sensitizing dye) according to necessity. The photosensitive composition for volume hologram recording according to the present invention may further include one or more other additives such as plasticizers within ranges not adversely affecting advantageous effects of the present invention.

Alicyclic Epoxy Compound (A)

The alicyclic epoxy compound (A) represented by Formula (I) is a non-ester alicyclic epoxy compound. In Formula (I), n represents an integer from 0 to 10; and X represents one divalent group selected from the group consisting of oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—. When n is 2 or more, two or more occurrences of X may be identical or different. When n is 0, X represents a single bond.

In Formula (I), R¹ to R¹⁸ are independently selected from a hydrogen atom, a halogen atom, a hydrocarbon group optionally containing oxygen or halogen, or an optionally substituted alkoxy group. R¹ to R¹⁸ may be identical or different. The halogen atom is exemplified by fluorine and chlorine atoms. Though not critical, the hydrocarbon group and the alkoxy group may each preferably have 1 to 5 carbon atoms. Namely, C₁-C₅ hydrocarbon groups and C₁-C₅ alkoxy groups are preferred. The hydrocarbon group optionally containing oxygen or halogen is exemplified by alkoxyalkyl groups such as methoxyethyl group; and haloalkyl groups such as trifluoromethyl group.

Among such alicyclic epoxy compounds (A), preferred are 3,4,3′,4′-diepoxybicyclohexyl, 2,2-bis(3,4-epoxycyclohexyl)propane, 2,2-bis(3,4-epoxycyclohexyl)-1,3-hexafluoropropane, bis(3,4-epoxycyclohexyl)methane, and 1-[1,1-bis(3,4-epoxycyclohexyl)]ethylbenzene. Commercial products may also be employed as the alicyclic epoxy compounds (A).

The photosensitive composition for volume hologram recording according to the present invention may employ each of different alicyclic epoxy compounds (A) alone or in combination.

The photosensitive composition for volume hologram recording according to the present invention may contain the alicyclic epoxy compound (A) in a content (amount) not critical, but preferably from 10 to 80 percent by weight, and more preferably from 15 to 75 percent by weight, based on the total amount (100 percent by weight) of cationically polymerizable compounds in the photosensitive composition for volume hologram recording. The photosensitive composition, if containing the alicyclic epoxy compound (A) in a content less than 10 percent by weight, may cause the volume hologram recording medium to shrink excessively upon curing in hologram recording (in hologram formation). In contrast, the photosensitive composition, if containing the alicyclic epoxy compound (A) in a content more than 80 percent by weight, may cause the volume hologram recording medium to be susceptible to cracking because of a relatively low content of the after-mentioned epoxy compound (E). When the photosensitive composition includes two or more alicyclic epoxy compounds (A), the term “alicyclic epoxy compound (A) in a content” refers to “alicyclic epoxy compounds (A) in a total content (total amount)”.

As used herein the term “cationically polymerizable compound” refers to a compound having at least one cationically polymerizable group per molecule, where the cationically polymerizable group is exemplified by epoxy, vinyl ether, and oxetanyl groups. Specifically, the alicyclic epoxy compound (A) and the after-mentioned epoxy compound (E) are included in the cationically polymerizable compounds.

Thermal Acid Generator (B)

The thermal acid generator (B) is not limited, as long as being a compound that activates (initiates) thermal cationic polymerization of cationically polymerizable compounds, but preferably exemplified by aromatic sulfonium salts such as commercial products under the trade names of San-Aid SI-60L, San-Aid SI-80L, San-Aid SI-100L, San-Aid SI-110L, and San-Aid SI-150L (each from SANSHIN CHEMICAL INDUSTRY CO., LTD.).

The photosensitive composition may contain the thermal acid generator (B) in a content (amount) not critical, but preferably from 0.1 to 30 parts by weight, and more preferably from 0.5 to 10 parts by weight, per 100 parts by weight of the total amount of cationically polymerizable compounds.

Radically Polymerizable Compound (C)

The radically polymerizable compound (C) is a compound having at least one radically polymerizable group (group having a radically polymerizable carbon-carbon unsaturated double bond) and is exemplified by acrylates, methacrylates, and vinyl compounds. Each of different radically polymerizable compounds (C) may be used alone or in combination. The radically polymerizable compound (C) for use herein is exemplified by photo-radically polymerizable compounds. Such photo-radically polymerizable compounds are not limited, as long as being compounds having a photo-radically polymerizable group, but are exemplified by compounds having at least one (preferably two or more) addition-polymerizable ethylenically unsaturated double bond. Preferred examples of the radically polymerizable compound (C) include unsaturated carboxylic acids; unsaturated carboxylic acid salts; ester compounds between an unsaturated carboxylic acid and an aliphatic polyhydric alcohol; and amide compounds between an unsaturated carboxylic acid and an aliphatic polyvalent amine compound. Each of different photo-radically polymerizable compounds may be used alone or in combination. They may be used in combination with one or more photo-cationically polymerizable compounds. Typical examples of the photo-radically polymerizable compounds are as follows.

The photo-radically polymerizable compounds are exemplified by styrene, 2-chlorostyrene, 2-bromostyrene, methoxystyrene, 1-vinylnaphthalene, 2-vinylnaphthalene, divinylbenzenes, 2-phenoxyethyl acrylate, bisphenol-A ethylene glycol monoacrylate, triethylene glycol monoacrylate, 1,3-butanediol monoacrylate, tetramethylene glycol monoacrylate, propylene glycol monoacrylate, neopentyl glycol monoacrylate, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolethane triacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol hexaacrylate, bisphenol-A ethylene glycol diacrylate, 2-phenoxyethyl methacrylate, ethylene glycol monomethacrylate, triethylene glycol monomethacrylate, 1,3-butanediol monomethacrylate, tetramethylene glycol monomethacrylate, propylene glycol monomethacrylate, neopentyl glycol monomethacrylate, ethylene glycol dimethacrylate, triethylene glycol dimethacrylate, 1,3-butanediol dimethacrylate, tetramethylene glycol methacrylate, propylene glycol dimethacrylate, neopentyl glycol dimethacrylate, trimethylolpropane trimethacrylate, trimethylolethane trimethacrylate, tetraethylene glycol dimethacrylate, pentaerythritol dimethacrylate, pentaerythritol trimethacrylate, pentaerythritol tetramethacrylate, dipentaerythritol dimethacrylate, dipentaerythritol trimethacrylate, dipentaerythritol tetramethacrylate, dipentaerythritol hexamethacrylate, and bisphenol-A ethylene glycol dimethacrylate.

The photosensitive composition may contain the radically polymerizable compound (C) in a content (amount) not critical, but preferably from 10 to 500 parts by weight, and more preferably from 50 to 300 parts by weight, per 100 parts by weight of the total amount of cationically polymerizable compounds.

Radical Polymerization Initiator (D)

The radical polymerization initiator (D) is not limited. However, the photosensitive composition, when containing a photo-radically polymerizable compound as the radically polymerizable compound (C), preferably employs a photo-radical polymerization initiator as the radical polymerization initiator (D). The photo-radical polymerization initiator is not limited, as long as being a compound that activates (initiates) photo-radical polymerization of the radically polymerizable compound (C), but is exemplified by peroxy esters such as 3,3′,4,4′-tetra(t-butylperoxycarbonyl)benzophenone (trade name BTTB, from NOF CORPORATION), a regioisomer mixture of 3,3′-di(t-butylperoxycarbonyl)-4,4′-di(methoxycarbonyl)benzophenone, 3,3′-di(methoxycarbonyl)-4,4′-(t-butylperoxycarbonyl)benzophenone, and 3,4′-di(t-butylperoxycarbonyl)-3′,4-di(methoxycarbonyl)benzophenone, and t-butyl peroxybenzoate (trade name PERBUTYL Z, from NOF CORPORATION); peroxides such as t-butyl hydroperoxide and di-t-butyl peroxide; benzoin and benzoin alkyl ethers, such as benzoin, benzoin methyl ether, benzoin ethyl ether, and benzoin isopropyl ether; acetophenones such as acetophenone, 2,2-dimethoxy-2-phenylacetophenone, 2,2-diethoxy-2-phenylacetophenone, 1,1-dichloroacetophenone, 2-methyl-1-[4-(methylthio)phenyl]-2-morpholino-propan-1-one, and 2-benzyl-2-dimethylamino-1-(4-morpholinophenyl)-butan-1-one; anthraquinones such as 2-methylanthraquinone, 2-ethylanthraquinone, 2-t-butylanthraquinone, 1-chloroanthraquinone, and 2-amylanthraquinone; thioxanthones such as 2,4-dimethylthioxanthone, 2,4-diethylthioxanthone, 2-chlorothioxanthone, and 2,4-isopropylthioxanthone; ketals such as acetophenone dimethyl ketal and benzyl dimethyl ketal; benzophenones such as benzophenone; xanthones; 1,7-bis(9-acridinyl)heptane; titanocene compounds such as Irgacure 784 (from BASF SE); as well as aromatic iodonium salts and aromatic sulfonium salts. Each of different radical polymerization initiators (D) (particularly, photo-radical polymerization initiators) may be used alone or in combination.

The photosensitive composition may contain the radical polymerization initiator (D) in a content (amount) not critical, but preferably from 0.1 to 30 parts by weight, and more preferably from 1 to 20 parts by weight, per 100 parts by weight of radically polymerizable compounds. Among such radical polymerization initiators (D), the photo-radical polymerization initiator(s) may be contained in a content (amount) not critical, but preferably from 0.1 to 30 parts by weight, and more preferably from 1 to 20 parts by weight, per 100 parts by weight of photo-radically polymerizable compounds.

Epoxy Compound (E)

The epoxy compound (E) for use in the photosensitive composition for volume hologram recording according to the present invention is at least one compound selected from the group consisting of compound represented by Formula (1), epoxidized fatty acid esters, and epoxidized conjugated diene polymers.

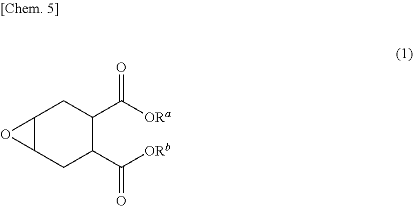

In Formula (1), R^{a} and R^{b} are independently selected from a monovalent linear or branched aliphatic hydrocarbon group and an epoxidized aliphatic hydrocarbon group. The “epoxidized aliphatic hydrocarbon group” refers to a monovalent group corresponding to a linear or branched unsaturated aliphatic hydrocarbon group, except with part or all of carbon-carbon unsaturated bond(s) thereof being epoxidized, namely, a group with part or all of the unsaturated bond(s) being converted into oxirane ring(s). R^{a} and R^{b} may be identical or different.

The monovalent linear or branched aliphatic hydrocarbon group is exemplified by monovalent saturated aliphatic hydrocarbon groups including alkyl groups such as methyl, ethyl, propyl, isopropyl, butyl, isobutyl, s-butyl, t-butyl, pentyl, hexyl, decyl, and dodecyl groups; and monovalent unsaturated aliphatic hydrocarbon groups including aliphatic hydrocarbon groups having one or more carbon-carbon unsaturated bonds, including alkenyl groups such as vinyl, allyl, and 1-butenyl groups, and alkynyl groups such as ethynyl and propynyl groups. Among them, preferred as the monovalent linear or branched aliphatic hydrocarbon group are C₆-C₃₀ linear or branched aliphatic hydrocarbon groups, and more preferred are C₈-C₂₀ linear or branched aliphatic hydrocarbon groups. They are preferred from the viewpoint of providing better storage stability of the volume hologram recording medium.

The epoxidized aliphatic hydrocarbon group is exemplified by monovalent groups corresponding to the monovalent unsaturated aliphatic hydrocarbon groups, except with part or all of carbon-carbon unsaturated bond(s) thereof being epoxidized. Among them, preferred are C₄-C₃₀ epoxidized aliphatic hydrocarbon groups, and more preferred are C₆-C₂₀ epoxidized aliphatic hydrocarbon groups.

Each of different compounds represented by Formula (1) may be used alone or in combination as the epoxy compound (E). The compounds represented by Formula (1) for use herein are also available as commercial products typically under the trade names of SANSO CIZER E-PS and SANSO CIZER E-PO (each from New Japan Chemical Co., Ltd.).

The epoxidized fatty acid esters are not limited, as long as being compounds having a structure corresponding to that of an unsaturated fatty acid ester, except with at least one carbon-carbon unsaturated bond of the unsaturated fatty acid ester being epoxidized. The epoxidized fatty acid esters are exemplified by esters between a fatty acid and an alcohol, in which the fatty acid corresponds to an unsaturated fatty acid, except with part or all of carbon-carbon unsaturated bond(s) thereof being epoxidized. The unsaturated fatty acid is exemplified by cis-9-octadecenoic acid (oleic acid), cis-9-hexadecenoic acid (palmitoleic acid), cis-11-octadecenoic acid (vaccenic acid), (Z,Z)-9,12-octadecadienoic acid (linoleic acid), (Z,Z,Z)-9,12,15-octadecatrienoic acid (linolenic acid), and cis-15-tetracosenoic acid (nervonic acid). The alcohol is exemplified by monovalent alcohols (including alkyl alcohols) such as methanol, ethanol, propanol, and butanol; and polyhydric alcohols such as glycerol, polyglycerols (e.g., diglycerol), pentaerythritol, ethylene glycol, diethylene glycol, propylene glycol, butylene glycol, trimethylolpropane, trimethylolethane, and sugar alcohols. Specifically, the epoxidized fatty acid esters are exemplified by epoxidized fatty acid esters (e.g., epoxidized fatty acid alkyl esters) of monovalent alcohols; and epoxidized fatty acid esters of polyhydric alcohols.

Specifically, the epoxidized fatty acid alkyl esters are exemplified by epoxidized fatty acid alkyl esters each having a C₁-C₃₀ (preferably C₃-C₁₈) linear or branched-chain alkyl group as an alkyl moiety constituting the alkyl ester, and are more specifically exemplified by 2-ethylhexyl esters of epoxidized fatty acids and butyl esters of epoxidized fatty acids.

Of the epoxidized fatty acid esters of polyhydric alcohols, preferred are epoxidized fatty acid esters of glycerol (epoxidized fatty acid glycerides). The epoxidized fatty acid glycerides are exemplified by compounds (epoxidized fatty acid triglycerides) represented by Formula (2):

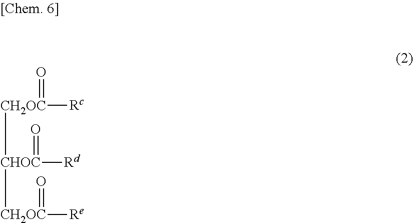

In Formula (2), R^{c}, R^{d}, and R^{e} are independently selected from a monovalent linear or branched aliphatic hydrocarbon group and an epoxidized aliphatic hydrocarbon group, where at least one of R^{c}, R^{d}, and R^{e} is an epoxidized aliphatic hydrocarbon group. The “epoxidized aliphatic hydrocarbon group” refers to a monovalent group corresponding to a linear or branched unsaturated aliphatic hydrocarbon group, except with part or all of carbon-carbon unsaturated bond(s) thereof being epoxidized. The monovalent linear or branched aliphatic hydrocarbon group and the epoxidized aliphatic hydrocarbon group are exemplified as with R^{a} and R^{b} in Formula (1). R^{c}, R^{d}, and R^{e} may be identical or different.

Among the compounds represented by Formula (2), particularly preferred are epoxidized fatty acid triglycerides in which all of R^{c}, R^{d}, and R^{e} are epoxidized aliphatic hydrocarbon groups.

More specifically, the epoxidized fatty acid glycerides are exemplified by epoxidized vegetable oils such as epoxidized soybean oils, epoxidized linseed oils, epoxidized castor oils, epoxidized rapeseed oils, and epoxidized sunflower oils; and epoxidized animal oils such as epoxidized fish oils.

Each of different epoxidized fatty acid esters may be used alone or in combination as the epoxy compound (E). The epoxidized fatty acid esters are also available as commercial products typically under the trade names of SANSO CIZER E-6000, SANSO CIZER E-2000H, SANSO CIZER E-9000H, and SANSO CIZER E-4030 (each from New Japan Chemical Co., Ltd.).

The epoxidized conjugated diene polymers are polymers corresponding to conjugated diene polymers, except with part or all of double bonds thereof being epoxidized. The epoxidized conjugated diene polymers are exemplified by epoxides of a homopolymer of a conjugated diene monomer; and epoxides of a copolymer of a conjugated diene monomer. The conjugated diene monomer is exemplified by butadiene (1,3-butadiene), isoprene, chloroprene, cyanobutadiene, pentadiene (1,3-pentadiene), 2-ethyl-1,3-butadiene, 2,3-dimethylbutadiene, 2-methylpentadiene, 4-methylpentadiene, and 2,4-hexadiene. The conjugated diene polymers may each employ each of different conjugated diene monomers alone or in combination as monomer components. The copolymer of the conjugated diene monomer may employ one or more monomers (monomer components) other than conjugated diene monomers. The monomers other than conjugated diene monomers are exemplified by styrene, acrylonitrile, methacrylonitrile, and olefins such as ethylene, propylene, 1-butene, isobutylene, cyclopentene, cyclohexene, norbornene, norbornadiene, and cyclododecatriene. The copolymer of the conjugated diene monomer may be a random copolymer, or a block copolymer such as a diblock copolymer or a triblock copolymer.

The conjugated diene polymers are exemplified by polybutadienes, polyisoprenes, polychloroprenes, polycyanobutadienes, polypentadienes, butadiene-isoprene copolymers, styrene-butadiene copolymers (e.g., styrene-butadiene-styrene block copolymers), and acrylonitrile-butadiene copolymers. Specifically, the epoxidized conjugated diene polymers are exemplified by epoxidized polybutadienes, epoxidized styrene-butadiene copolymers, and other polymers corresponding to the conjugated diene polymers, except with part or all of carbon-carbon unsaturated bonds (particularly, carbon-carbon unsaturated double bonds) thereof being epoxidized.

Each of different epoxidized conjugated diene polymers may be used alone or in combination as the epoxy compound (E). The epoxidized conjugated diene polymers are also available as commercial products typically under the trade name of EPOLEAD PB3600 (from Daicel Corporation).

The photosensitive composition for volume hologram recording according to the present invention may employ each of different epoxy compounds (E) alone or in combination.

The epoxy compound (E) may have an epoxy equivalent not critical, but preferably from 70 to 1000, more preferably from 70 to 700, and furthermore preferably from 70 to 500. The epoxy compound (E), if having an epoxy equivalent less than 70, may fail to sufficiently effectively help the recording layer of the volume hologram recording medium to resist cracking. In contrast, the epoxy compound (E), if having an epoxy equivalent more than 1000, may cause the volume hologram recording medium to excessively shrink upon curing in hologram recording (in hologram formation). The epoxy equivalent of the epoxy compound (E) can be determined typically by calculation of dividing the molecular number by the number of epoxy groups per molecule [(molecular weight)/(number of epoxy groups per molecule)] or by measurement according to JIS K7236.

The photosensitive composition may contain the epoxy compound (E) in a content not critical, but preferably from 50 to 500 parts by weight, more preferably from 70 to 450 parts by weight, and furthermore preferably from 80 to 400 parts by weight, per 100 parts by weight of the total amount of cationically polymerizable compound(s) other than the epoxy compound (E). The photosensitive composition, if containing the epoxy compound (E) in a content less than 50 parts by weight, may cause the recording layer of the volume hologram recording medium to be susceptible to cracking. In contrast, the photosensitive composition, if containing the epoxy compound (E) in a content more than 500 parts by weight, may cause the volume hologram recording medium to shrink excessively upon curing in hologram recording (in hologram formation).

Sensitizing Dye

The sensitizing dye for use herein is not limited, as long as capable of sensitizing a photoinitiator, and can be any of known ones. The sensitizing dye is exemplified by thiopyrylium salt dyes, melocyanine dyes, quinoline dyes, styrylquinoline dyes, ketocoumarin dyes, thioxanthene dyes, xanthene dyes, oxonol dyes, cyanine dyes, rhodamine dyes, and pyrylium salt dyes. The sensitizing dye, when being a visible light sensitizing dye and used in optical elements and other applications requiring high transparency, is preferably one that will be decomposed into a colorless transparent substance by the application of heat or an ultraviolet ray in a downstream process from the hologram recording. Each of different sensitizing dyes may be used alone or in combination. Among them, cyanine dyes are preferred as the sensitizing dye.

Other Cationically Polymerizable Compound

The photosensitive composition for volume hologram recording according to the present invention, when subjected to a heat treatment, gives a photosensitive composition for volume hologram recording including a three-dimensionally crosslinked polymer matrix. Cationically polymerizable compounds in the material photosensitive composition act as precursors to form the three-dimensionally crosslinked polymer matrix. The precursors are hereinafter also referred to as “three-dimensionally crosslinked polymer matrix precursor materials”. Specifically, the three-dimensionally crosslinked polymer matrix is composed of a cured product that is formed by cationic polymerization of the cationically polymerizable compounds in the photosensitive composition for volume hologram recording.

The photosensitive composition for volume hologram recording according to the present invention may further include one or more other cationically polymerizable compounds as cationically polymerizable compounds (namely, three-dimensionally crosslinked polymer matrix precursor materials), where the “other cationically polymerizable compounds” refers to those other than the alicyclic epoxy compounds (A) and the epoxy compounds (E). Each of the other cationically polymerizable compounds may be used alone or in combination. The other cationically polymerizable compounds are exemplified by epoxy compounds other than the alicyclic epoxy compounds (A) and the epoxy compounds (E); oxetane compounds (compounds having at least one oxetanyl group per molecule); and vinyl ether compounds (compounds having at least one vinyl ether group per molecule).

The other epoxy compounds than the alicyclic epoxy compounds (A) and epoxy compounds (E) (hereinafter also referred to as “other epoxy compound(s)”) are exemplified by other alicyclic epoxy compounds; and glycidyl-containing epoxy compounds (epoxy resins), where the “other alicyclic epoxy compounds” refers to alicyclic epoxy compounds that are other than the alicyclic epoxy compounds (A) and the compounds represented by Formula (1) and have at least one alicyclic group and at least one epoxy group per molecule. Among them, preferred are the other alicyclic epoxy compounds are preferred; and more preferred are compounds having an epoxy group (oxirane ring) formed as including adjacent two carbon atoms constituting the alicyclic group. The other epoxy compounds may be either monofunctional epoxy compounds or multifunctional epoxy compounds, but are preferably multifunctional epoxy compounds. Each of different other epoxy compounds may be used alone or in combination.

Specifically, the other alicyclic epoxy compounds are exemplified by bis(3,4-epoxycyclohexyl)adipate, 3,4-epoxycyclohexylmethyl(3,4-epoxy)cyclohexanecarboxylate, (3,4-epoxy-6-methylcyclohexyl)methyl-3′,4′-epoxy-6-methylcyclohexanecarboxylate, ethylene-1,2-bis(3,4-epoxycyclohexanecarboxylic acid) ester, 3,4-epoxycyclohexylmethyl alcohol, 3,4-epoxycyclohexylethyltrimethoxysilane, and 1,2-epoxy-4-(2-oxiranyl)cyclohexene adduct of 2,2-bis(hydroxymethyl)-1-butanol. The other alicyclic epoxy compounds are also available as commercial products typically under the trade names of CELLOXIDE 2000, CELLOXIDE 2021, CELLOXIDE 3000, and EHPE3150 from Daicel Corporation.

Examples of the other epoxy compounds for use herein also include commercial products typically under the trade name of 1031S from Mitsubishi Chemical Corporation; under the trade names of TETRAD-X and TETRAD-C from MITSUBISHI GAS CHEMICAL COMPANY, INC.; and under the trade name of EPB-13 from Nippon Soda Co., Ltd.

The compounds having at least one vinyl ether group (vinyl ether compounds) are not limited, as long as being compounds having at least one vinyl ether group, and may be either monofunctional vinyl ether compounds or multifunctional vinyl ether compounds. Among them, multifunctional vinyl ether compounds are particularly preferred. Each of different vinyl ether compounds may be used alone or in combination.

Specifically, the vinyl ether compounds are exemplified by vinyl ethers of cyclic ether type (vinyl ethers having a cyclic ether group such as oxirane, oxetane, or oxolane ring), such as isosorbide divinyl ether and oxynorbornene divinyl ether; aryl vinyl ethers such as phenyl vinyl ether; alkyl vinyl ethers such as n-butyl vinyl ether and octyl vinyl ether; cycloalkyl vinyl ethers such as cyclohexyl vinyl ether; and multifunctional vinyl ethers such as hydroquinone divinyl ethers, 1,4-butanediol divinyl ether, cyclohexane divinyl ethers, and cyclohexanedimethanol divinyl ethers. Exemplary vinyl ether compounds for use herein further include 2-hydroxyethyl vinyl ether (HEVE), diethylene glycol monovinyl ether (DEGV), 2-hydroxybutyl vinyl ether (HBVE), and triethylene glycol divinyl ether each supplied by Maruzen Petrochemical Co., Ltd. Exemplary vinyl ether compounds for use herein still further include vinyl ether compounds having a substituent at the alpha-position and/or beta-position (carbon atom at the alpha position and/or the beta-position to ether oxygen). The substituent is exemplified by alkyl groups, allyl groups, aryl groups, and alkoxy groups.

The compounds having at least one oxetanyl group (oxetane compounds) are not limited, as long as being oxetanyl-containing compounds, and may be either monofunctional oxetane compounds or multifunctional oxetane compounds. Among them, multifunctional oxetane compounds are particularly preferred. Each of different oxetane compounds may be used alone or in combination.

The oxetane compounds are specifically exemplified by 3-ethyl-3-(phenoxymethyl)oxetane (PDX), di[1-ethyl(3-oxetanyl)]methyl ether (DOX), 3-ethyl-3-(2-ethylhexyloxymethyl)oxetane (EHOX), 3-ethyl-3-{[3-(triethoxysilyl)propoxy]methyl}oxetane (TESOX), oxetanylsilsesquioxane (OX-SQ), and phenol-novolak oxetane (PNOX-1009) each supplied by Toagosei Co., Ltd. Exemplary oxetane compounds for use herein further include compounds having two or more different cationically polymerizable groups (e.g., oxetanyl group and vinyl ether group) per molecule, such as 3,3-dimethanoloxetane divinyl ether.

Each of different other cationically polymerizable compounds may be used alone or in combination in the photosensitive composition for volume hologram recording according to the present invention.

The photosensitive composition for volume hologram recording according to the present invention may contain the alicyclic epoxy compound(s) (A) and the other cationically polymerizable compound(s) in a ratio (weight ratio) of the former to the latter not critical, but preferably from 5:95 to 95:5, more preferably from 20:80 to 80:20, furthermore preferably from 30:70 to 70:30, and particularly preferably from 40:60 to 60:40.

As is described above, the photosensitive composition for volume hologram recording according to the present invention, when subjected to a heat treatment, undergoes the proceeding of cationic polymerization of cationically polymerizable compounds (the alicyclic epoxy compound(s) (A), the other cationically polymerizable compound(s), and the epoxy compound(s) (E)) contained in the composition and gives a photosensitive composition for volume hologram recording including at least a three-dimensionally crosslinked polymer matrix; the radically polymerizable compound (C); and the radical polymerization initiator (D) (this composition is hereinafter also referred to as “polymer-matrix-containing photosensitive composition”) in which the three-dimensionally crosslinked polymer matrix includes a cured product of the cationically polymerizable compounds. The heat treatment may be performed under any conditions not critical, as long as capable of curing the cationically polymerizable compounds to form the three-dimensionally crosslinked polymer matrix. Typically, conditions for a heat treatment to form the volume hologram recording medium as mentioned later can be employed.

### Volume Hologram Recording Medium

A volume hologram recording medium according to an embodiment of the present invention is a volume hologram recording medium having at least a volume hologram recording layer, where the volume hologram recording layer includes the polymer-matrix-containing photosensitive composition. The polymer-matrix-containing photosensitive composition is a photosensitive composition for volume hologram recording that is formed by subjecting the photosensitive composition for volume hologram recording according to the present invention to a heat treatment and essentially includes a three-dimensionally crosslinked polymer matrix; the radically polymerizable compound (C); and the radical polymerization initiator (D). The three-dimensionally crosslinked polymer matrix includes a cured product of the cationically polymerizable compounds. Specific embodiments of the volume hologram recording medium according to the present invention include a volume hologram recording medium containing a first substrate; a second substrate; and the volume hologram recording layer between the first and second substrates. Specifically, the volume hologram recording medium according to the present invention can be produced typically by holding the photosensitive composition for volume hologram recording according to the present invention between a pair of substrates (first and second substrates) to give a laminate, and subjecting the laminate to a heat treatment. The volume hologram recording medium according to the present invention may typically be a transmission volume hologram recording medium.

Volume Hologram Recording Layer

The volume hologram recording layer in the volume hologram recording medium according to the present invention is formed from the photosensitive composition for volume hologram recording and can be formed by holding the photosensitive composition for volume hologram recording between a pair of substrates to give a laminate; and subjecting the laminate to a heat treatment. The heat treatment may be performed for such a duration as to complete the curing reaction of the three-dimensional polymer matrix precursor materials (cationically polymerizable compounds) in the system. Aging may be performed after the heat treatment by leaving the resulting article stand for a predetermined time. Such aging after the heat treatment can give a volume hologram recording layer that has excellent water-vapor resistance and thermal stability and further less shrinks upon curing.

The heat treatment step to form the volume hologram recording layer can be performed in an oven under light-blocking conditions. The heating in the heat treatment step may be performed at a temperature not critical, but preferably from 40° C. to 300° C., and more preferably from 40° C. to 150° C. The heating may also be performed for a time not critical, but preferably from 10 minutes to 5 hours, and more preferably from 10 minutes to 3 hours. The heating, if performed for a time shorter than 10 minutes, may cause the curing reaction to fail to complete even when the downstream aging step is performed. The heating, if performed for a time longer than 5 hours, may cause a reaction of the radically polymerizable compound (C) to proceed, and this may cause the volume hologram recording medium to have insufficient hologram properties.

The aging step is a process of subjecting cationically polymerizable compounds to a dark reaction under light-blocking conditions to settle the reaction in the medium. When curing of the cationically polymerizable compounds is insufficient even after the heat treatment, the aging step can complete the curing reaction of the cationically polymerizable compounds in the volume hologram recording layer. How the curing reaction proceeds can be determined herein typically by evaluating the formed film (film of the photosensitive composition for volume hologram recording after the heat treatment) typically with an infrared spectrometer (IR) or a DSC. The aging step also includes the step of returning the volume hologram recording medium after the heat treatment sufficiently down to room temperature. The volume hologram recording medium, when sufficiently returned down to room temperature after the heating, can offer stable hologram properties.

The aging in the aging step may be performed at a temperature not critical, but preferably from −15° C. to lower than 40° C., more preferably from 0° C. to 35° C., and furthermore preferably about 25° C. (room temperature). The aging may be performed for a time not critical, but preferably from about 5 minutes to about one week, more preferably from about 10 minutes to about 4 days, and furthermore preferably from about 30 minutes to about 48 hours, while the aging time may be determined according to the time necessary for the completion of the curing reaction. The aging temperature and aging time may be suitably set on a photosensitive composition basis, because the time necessary to completely cure cationically polymerizable groups (e.g., epoxy groups) varies depending on the formulation of the photosensitive composition for volume hologram recording.

The volume hologram recording layer in the volume hologram recording medium according to the present invention may have a thickness not critical, but preferably from 1 to 2000 μm, and more preferably from 10 to 1000 μm. Generally, the volume hologram recording layer, if having an excessively small thickness, may often give a hologram with low angular selectivity; whereas the volume hologram recording layer, if having a large thickness, can give a hologram with high angular selectivity.

The volume hologram recording medium according to the present invention may have a transmittance not critical, but preferably 80% or more, and more preferably 85% or more. The “transmittance of the volume hologram recording medium” refers to a transmittance after a hologram is recorded and fixed in the recording medium by irradiating the recoding medium with a laser beam to polymerize the radically polymerizable compound (C) in the photosensitive composition for volume hologram recording (polymer-matrix-containing photosensitive composition). Namely, the transmittance is determined after the completion of the reaction of the radically polymerizable compound (C). The fixation may be performed by the application of light such as an UV, laser beam, or light emitted from an LED. As used herein the term “transmittance” refers to a transmittance at a recording wavelength (equal to a reading wavelength). The recording medium, when having a transmittance of 80% or more, may lose less energy and thereby readily enable efficient reading of the recorded hologram. In contrast, the recording medium, if having a transmittance less than 80%, may suffer from adverse effects such as high noise level of a read image.

Base (Substrate)

The bases (substrates) for use in the volume hologram recording medium according to the present invention are not limited, as long as having transparency to visible light, and are exemplified by glass sheets; and plastic films (including plastic sheets) such as cycloolefinic polymer films (e.g., TOPAS supplied by Daicel Corporation), polyethylene films, polypropylene films, poly(ethylene fluoride) films, poly(vinylidene fluoride) films, poly(vinyl chloride) films, poly(vinylidene chloride) films, poly(methyl methacrylate) films, polycarbonate (PC) films, poly(ether-sulfone) films, poly(ether-ketone) films, polyamide films, tetrafluoroethylene-perfluoroalkyl vinyl ether copolymer films, polyester films (e.g., poly(ethylene terephthalate) (PET) films), and polyimide films. Each of different bases may be used alone or in combination. Specifically, the pair of substrates (first and second substrates) may be of identical or different types.

### Hologram Recording Method

A method for recording (writing) a hologram in the volume hologram recording medium according to the present invention (hologram recording method) is not limited and can be any of known methods. Specifically, hologram recording can be performed by a method of irradiating the volume hologram recording medium with an active energy ray (e.g., light or electron beams) so as to polymerize the radically polymerizable compound (C) in the photosensitive composition for volume hologram recording. More specifically, exemplary hologram recording methods or processes include a contact exposure process; a single-beam interference process; a two-beam interference process; and a collinear process. In the contact exposure process, a master plate is brought into intimate contact with the volume hologram recording medium, and visible light or ionizing radiation (e.g., ultraviolet ray or electron beam) is applied from the surface of a transparent base film to perform interference exposure to thereby record a volume hologram. In the single-beam interference process, the medium is arranged between a pair of glass or film, and a laser beam is applied through the surface of the medium to the master plate to record a volume hologram by the interference between a reflected laser beam from the master plate and an incident laser beam. In the two-beam interference process, laser beams are divided into two directions, of which one is applied directly to the photosensitive material; and the other is applied once to a substance having information to be recorded and passes through the substance, and the resulting beam (information beam or signal beam) is then applied to the photosensitive material to record or write a hologram. In the collinear process, an information beam and a reference beam are applied coaxially.

The hologram recording as mentioned above can employ visible laser beams such as laser beams typically from argon ion laser (458 nm, 488 nm, or 514.5 nm), krypton ion laser (647.1 nm), helium-neon ion laser (633 nm), YAG laser (532 nm), and semiconductor laser (405 nm).

After the interference exposure, a treatment such as whole image exposure by the application of an ultraviolet ray or heat may be performed suitably so as to promote the refractive-index modulation and to complete the polymerization reaction (to fix the hologram).

A hologram recording mechanism using the photosensitive composition for volume hologram recording will be described as follows. Specifically, assume that the volume hologram photosensitive composition (the polymer-matrix-containing photosensitive composition) is formed into a film as a volume hologram recording layer, and the volume hologram recording layer is subjected to interference exposure to an active energy ray (particularly, a laser beam). In this case, the polymerization of a photo-curable compound (the radically polymerizable compound (C) in the present invention) is initiated in a region irradiated with high-intensity light. Accompanied with this, concentration gradient of the photopolymerizable compound occurs, and the photopolymerizable compound diffuses and migrates from a region irradiated with low-intensity light to the region irradiated with the high-intensity light. This causes the difference in density of the photopolymerizable compound corresponding to the difference in intensity of interference fringes, resulting in a difference in refractive index. The difference in refractive index enables the recording of a hologram.

The volume hologram recording medium according to the present invention less shrinks upon curing and can achieve excellent diffraction efficiency particularly by using the non-ester alicyclic epoxy compound (A) having the structure represented by Formula (I) to form a three-dimensionally crosslinked polymer matrix. The volume hologram recording medium may have a diffraction efficiency not critical, but preferably 10% or more, more preferably 50% or more, and furthermore preferably 80% or more. The volume hologram recording medium may have a curing shrinkage (shrinkage percentage) not critical, but preferably 1.5% or less, more preferably 0.5% or less, and particularly preferably 0.3% or less. The diffraction efficiency and shrinkage percentage can be determined typically by evaluation methods described in the examples below.

### EXAMPLES

The present invention will be illustrated in further detail with reference to several examples below. It should be noted, however, that the examples are by no means intended to limit the scope of the invention.

Optical System

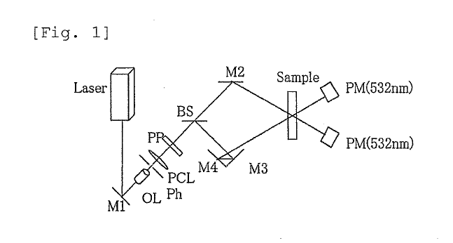

FIG. 1 depicts a schematic diagram of an optical system used for the measurement of the diffraction efficiency and shrinkage percentage. A light source used herein was 532-nm semiconductor laser, and laser beams emitted therefrom traveled via a mirror (M), spatial filters (OL and Ph), a planoconvex lens (PCL), and a wave plate (PP) and were split into two beams by a beam splitter (BS). The two beams split by the BS were applied via mirrors to the sample at angles of 30 degrees and 30 degrees, respectively, and thereby interfered. The intensities of a diffracted beam and a transmitted beam were respectively detected with power meters (PM: supplied by ADC Corporation).

The diffraction efficiency was determined by a method as follows.

Diffraction Efficiency

A hologram was recorded by the two-beam interference process, and the diffraction efficiency of the hologram was measured with the power meters. Two laser beams emitted from 532-nm semiconductor laser having a diameter of 5 were applied each at an incident angle of 30 degrees, and the transmitted beam and diffracted beam were detected. The volume hologram recording medium was axially rotated at angles from −5 degrees to 5 degrees, and the diffraction efficiency η was calculated at a position where the diffracted light intensity reached maximum, according to Expression 1:

η=L₁/(L₀+L₁) (Expression 1)

wherein L₀ represents the transmitted beam intensity; and L₁ represents the diffracted beam intensity.

Curing Shrinkage

The sample volume hologram recording medium was arranged at an inclination of 10 degrees, and hologram recording was performed with a recording beam and a reference beam at angles of 20 degrees and 40 degrees, respectively. Thereafter the reference beam was applied at an incident angle of 40 degrees, and an angle (θ₁) at which the medium exhibited a maximum diffraction efficiency was detected. If the recording medium does not shrink, the maximum diffraction efficiency be obtained at an angle of 40 degrees. However, if the recording medium shrinks, the angle deviate from 40 degrees. In addition, the recording beam alone was applied at an incident angle of 20 degrees, and an angle (θ₂) at which the recording medium exhibited a maximum diffraction efficiency was detected in the same manner as above. Grating vectors (K₁ and K₂) of the recording medium in a thickness direction were determined from the detected angles according to Expressions 2 and 3, and based on them, the shrinkage percentage was calculated according to Expression 4. The light source for the recording beam and the reference beam was as in the measurement of the diffraction efficiency:

K₁=(2π/λ){(n²−sin² θ₁)^{1/2}}−(n²−sin² θ₂)^{1/2}}} (Expression 2)

wherein λ represents the recording wavelength; n represents the refractive index of the recording layer; and θ₁ and θ₂ represent incident angles (40 degrees and 20 degrees, respectively) before recording;

K₂=(2π/λ){(n²−sin² θ₁′)^{1/2}}−(n²−sin² θ₂′)^{1/2}}} (Expression 3)

wherein A represents the recording wavelength; n represents the refractive index of the recording layer; and θ₁′ and θ₂′ represent incident angles at which the diffraction efficiency reaches maximum;

Shrinkage percentage (%)=(K₁−K₂)/K₁×100 (Expression 4)

wherein K₁ represents the grating vector before recording; and K₂ represents the grating vector after recording.

Storage Stability

Volume hologram recording media each having a recording layer (volume hologram recording layer) with a thickness of 500 μm were prepared using the photosensitive compositions for volume hologram recording obtained in the examples and comparative examples, subjected to recording and fixing of a hologram, and left stand at room temperature for one week. Whether or not the volume hologram recording layer suffered from cracking after being left stand was visually determined. A sample not suffering from cracking was evaluated as “Good” (having good storage stability); whereas a sample suffering from cracking was evaluated as “Poor” (having poor storage stability).

A 0.85-mm thick glass substrate was used as the substrates (a pair of substrates) in the volume hologram recording media. The hologram recording and fixing were performed under conditions as follows:

Light wavelength: 532 nm (semiconductor laser)

Hologram recording: at an intensity of 1 mW/cm² and a quantity of light (exposure energy) of 100 mJ/cm²

Fixing: at an intensity of 10 mW/cm² and a quantity of light of 600 mJ/cm²

### Example 1

A photosensitive solution (photosensitive composition for volume hologram recording) was prepared by blending and stirring components to dissolve the respective components uniformly. The components were 50 parts by weight of a trifunctional acrylate compound, i.e., pentaerythritol triacrylate (trade name A-TMM-3, supplied by Shin-Nakamura Chemical Co., Ltd.) as a radically polymerizable compound; 25 parts by weight of a bifunctional alicyclic epoxy compound (3,4,3′,4′-diepoxybicyclohexyl) and 25 parts by weight of di-(2-ethylhexyl) epoxyhexahydrophthalate (trade name SANSO CIZER E-PS, supplied by New Japan Chemical Co., Ltd.) as cationically polymerizable compounds; 12.5 parts by weight (amount as a solution having a solids concentration of 40 percent by weight) of 3,3′,4,4′-tetra(t-butylperoxycarbonyl)benzophenone as a photo-radical polymerization initiator; 0.774 part by weight (amount as a solution having a solids concentration of 32.3 percent by weight) of a triphenylsulfonium salt (trade name San-Aid SI-60L, supplied by SANSHIN CHEMICAL INDUSTRY CO., LTD.) as a thermal acid generator; and 0.025 part by weight of 3-ethyl-2-[3-(3-ethyl-5-phenyl-2-benzoxazolinylidene)propenyl]-5-phenylbenzoxazolium bromide (cyanine dye) as a sensitizing dye.

The above-prepared photosensitive solution was held together with a 100-μm thick spacer film (PET) between a pair of glass substrates (3 cm long by 3 cm wide by 1 mm thick), followed by sealing of the periphery thereof. The resulting article was heated in an oven at 90° C. for one hour, retrieved from the oven, aged at room temperature (r.t.: about 25° C.) for one hour, and thereby yielded a volume hologram recording medium having a thickness of the volume hologram recording layer of 100 μm. A transmission hologram was recorded in the volume hologram recording medium using semiconductor laser at a wavelength of 532 nm, a light intensity of 1 mW/cm², and an exposure energy of 100 mJ/cm². As a result, the recording medium exhibited a maximum diffraction efficiency of 38% and a curing shrinkage percentage of 0.2%. In addition, a volume hologram recording medium (having a thickness of a volume hologram recording layer of 500 μm) used in storage stability evaluation was prepared by the above procedure, except for using a 500-μm thick spacer film and using another substrate.

### Examples 2 to 12 and Comparative Examples 1 to 3

Volume hologram recording media (those having thicknesses of the volume hologram recording layer of 100 μm and 500 μm) were prepared by the procedure of Example 1, except for using different radically polymerizable compounds, cationically polymerizable compounds, photo-radical polymerization initiators, thermal acid generators, sensitizing dyes, and plasticizers in amounts as give in Table 1. The diffraction efficiency and shrinkage percentage were measured on the volume hologram recording media having a thickness of the volume hologram recording layer of 100 μm; whereas the storage stability was evaluated on the volume hologram recording media having a thickness of the volume hologram recording layer of 500 μm. The heating conditions upon preparation of the volume hologram recording media and the evaluation results are indicated in Table 1. The amounts of the respective components in Table 1 are indicated in part by weight. The amount of the photo-radical polymerization initiator (3,3′,4,4′-tetra(t-butylperoxycarbonyl)benzophenone) in Table 1 is indicated as the amount of the solution (having a solids concentration of 40 percent by weight) of the photo-radical polymerization initiator. Likewise, the amount of the thermal acid generator in Table 1 is indicated as the amount of the solution (having a solids concentration of 32.3 percent by weight) of the thermal acid generator.

TABLE 1

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Photosensitive | Radically polymerizable | c-1 | 50 | 50 | 50 | 50 | 50 | 50 | 50 | 50 |
| composition for | compound | c-2 | — | — | — | — | — | — | — | — |
| volume | | c-3 | — | — | — | — | — | — | — | — |
| hologram | | c-4 | — | — | — | — | — | — | — | — |
| recording | Cationically | a-1 | 25 | 18.8 | 11.5 | 25 | 25 | 25 | 25 | 25 |
| | polymerizable | a′-1 | — | — | — | — | — | — | — | — |
| | compound | e-1 | 25 | 31.2 | 38.5 | — | — | — | — | — |
| | | e-2 | — | — | — | 25 | — | — | — | — |
| | | e-3 | — | — | — | — | 25 | — | — | — |
| | | e-4 | — | — | — | — | — | 25 | — | — |
| | | e-5 | — | — | — | — | — | — | 25 | — |
| | | e-6 | — | — | — | — | — | — | — | 25 |
| | | e-7 | — | — | — | — | — | — | — | — |
| | Plasticizer | f-1 | — | — | — | — | — | — | — | — |
| | Photoradical | d-1 | 12.5 | 12.5 | 12.5 | 12.5 | 12.5 | 12.5 | 12.5 | 12.5 |
| | polymerization initiator | | | | | | | | | |
| | Thermal acid generator | b-1 | 0.774 | 0.774 | 0.774 | 0.774 | 0.774 | 0.774 | 0.774 | 0.774 |
| | Sensitizing dye | g-1 | 0.025 | 0.025 | 0.025 | 0.025 | 0.025 | 0.025 | 0.025 | 0.025 |

| Heating condition | | 90° C. | 90° C. | 90° C. | 90° C. | 90° C. | 90° C. | 90° C. | 90° C. |
|---|---|---|---|---|---|---|---|---|---|
| | | for 1 hr | for 1 hr | for 1 hr | for 1 hr | for 1 hr | for 1 hr | for 1 hr | for 1 hr |
| Volume | Recording layer thickness (μm) | 100 | 100 | 100 | 100 | 100 | 100 | 100 | 100 |
| hologram | Diffraction efficiency (%) | 38 | 70 | 65 | 25 | 32 | 45 | 33 | 48 |
| recording | Shrinkage percentage (%) | 0.2 | 0.19 | 0.18 | 0.18 | 0.17 | 0.21 | 0.17 | 0.24 |
| medium | Storage stability | Good | Good | Good | Good | Good | Good | Good | Good |

| | | | | | | | Com | Com | Com |
|---|---|---|---|---|---|---|---|---|---|
| | | | Ex. 9 | Ex. 10 | Ex. 11 | Ex. 12 | Ex. 1 | Ex. 2 | Ex. 3 |
| Photosensitive | Radically polymerizable | c-1 | 50 | — | — | — | 50 | 50 | 50 |
| composition for | compound | c-2 | — | 50 | — | — | — | — | — |
| volume | | c-3 | — | — | 50 | — | — | — | — |
| hologram | | c-4 | — | — | — | 50 | — | — | — |
| recording | Cationically | a-1 | 25 | 25 | 25 | 25 | 25 | 50 | — |
| | polymerizable | a′-1 | — | — | — | — | — | — | 50 |
| | compound | e-1 | — | 25 | 25 | 25 | — | — | — |
| | | e-2 | — | — | — | — | — | — | — |
| | | e-3 | — | — | — | — | — | — | — |
| | | e-4 | — | — | — | — | — | — | — |
| | | e-5 | — | — | — | — | — | — | — |
| | | e-6 | — | — | — | — | — | — | — |
| | | e-7 | 25 | — | — | — | — | — | — |
| | Plasticizer | f-1 | — | — | — | — | 25 | — | — |
| | Photoradical | d-1 | 12.5 | 12.5 | 12.5 | 12.5 | 12.5 | 12.5 | 12.5 |
| | polymerization initiator | | | | | | | | |
| | Thermal acid generator | b-1 | 0.774 | 0.774 | 0.774 | 0.774 | 0.774 | 0.774 | 0.774 |
| | Sensitizing dye | g-1 | 0.025 | 0.025 | 0.025 | 0.025 | 0.025 | 0.025 | 0.025 |

| Heating condition | | 90° C. | 90° C. | 90° C. | 90° C. | 90° C. | 90° C. | 90° C. |
|---|---|---|---|---|---|---|---|---|
| | | for 1 hr | for 1 hr | for 1 hr | for 1 hr | for 1 hr | for 1 hr | for 1 hr |
| Volume | Recording layer thickness (μm) | 100 | 100 | 100 | 100 | 100 | 100 | 100 |
| hologram | Diffraction efficiency (%) | 38 | 92 | 88 | 67 | 80 | 20 | 18 |
| recording | Shrinkage percentage (%) | 0.22 | 0.18 | 0.22 | 0.26 | 0.19 | 0.12 | 0.36 |
| medium | Storage stability | Good | Good | Good | Good | Poor | Poor | Poor |

The compounds indicated in Table 1 are as follows:

### Radically Polymerizable Compound

c-1: A-TMM-3 (trade name, supplied by Shin-Nakamura Chemical Co., Ltd., pentaerythritol triacrylate)

c-2: A-LEN-10 (trade name, supplied by Shin-Nakamura Chemical Co., Ltd., hydroxyethylated o-phenylphenol acrylate)

c-3: A-BPEF (trade name, supplied by Shin-Nakamura Chemical Co., Ltd., 9,9-bis[4-(2-acryloyloxyethoxyl)phenyl]fluorene)

c-4: A-BPE-4 (trade name, supplied by Shin-Nakamura Chemical Co., Ltd., ethoxylated bisphenol-A diacrylate)

### Cationically Polymerizable Compound

a-1: 3,4,3′,4′-Diepoxybicyclohexyl

a′-1: CEL2021P (trade name, supplied by Daicel Corporation, 3,4-epoxycyclohexylmethyl(3,4-epoxy)cyclohexanecarboxylate)

e-1: SANSO CIZER E-PS (trade name, supplied by New Japan Chemical Co., Ltd., di(2-ethylhexyl) epoxyhexahydrophthalate)

e-2: SANSO CIZER E-PO (trade name, supplied by New Japan Chemical Co., Ltd., diepoxystearyl epoxyhexahydrophthalate)

e-3: SANSO CIZER E-6000 (trade name, supplied by New Japan Chemical Co., Ltd., epoxidized fatty acid 2-ethylhexyl ester)

e-4: SANSO CIZER E-2000H (trade name, supplied by New Japan Chemical Co., Ltd., epoxidized soybean oil)

e-5: EPOLEAD PB3600 (trade name, supplied by Daicel Corporation, epoxidized polybutadiene)

e-6: SANSO CIZER E-9000H (trade name, supplied by New Japan Chemical Co., Ltd., epoxidized linseed oil)

e-7: SANSO CIZER E-4030 (trade name, supplied by New Japan Chemical Co., Ltd., epoxidized fatty acid butyl ester)

### Plasticizer

f-1: Diethyl sebacate

### Photoradical Polymerization Initiator

d-1: 3,3′,4,4′-Tetra(t-butylperoxycarbonyl)benzophenone

### Thermal Acid Generator

b-1: San-Aid SI-60L (trade name, supplied by SANSHIN CHEMICAL INDUSTRY CO., LTD.)

### Sensitizing Dye

g-1: Cyanine dye

### INDUSTRIAL APPLICABILITY

The use of the photosensitive compositions for volume hologram recording according to embodiments of the present invention provides hologram recording media and hologram recording methods using the recording media, which hologram recording media offer a high storage capacity and high refractive-index modulation and less change in volume upon light irradiation.

1. A photosensitive composition for volume hologram recording, comprising:
an alicyclic epoxy compound (A) represented by Formula (I);
a thermal acid generator (B);
a radically polymerizable compound (C);
a radical polymerization initiator (D); and
at least one epoxy compound (E) selected from the group consisting of:
compounds represented by Formula (1);
epoxidized fatty acid esters; and
epoxidized conjugated diene polymers,
Formulae (I) and (1) expressed as follows: 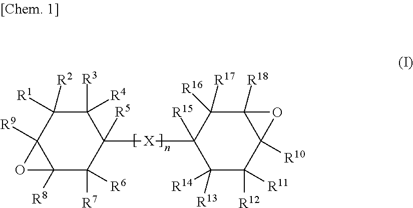
wherein n represents an integer from 0 to 10; X represents, in each occurrence independently, one divalent group selected from the group consisting of oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R′⁸ are, identically or differently, selected from a hydrogen atom, a halogen atom, a hydrocarbon group optionally containing oxygen or halogen, and optionally substituted alkoxy group; 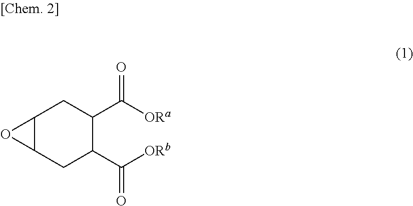
wherein R^{a} and R^{b} are independently selected from a monovalent linear or branched aliphatic hydrocarbon group; and a monovalent group corresponding to a linear or branched unsaturated aliphatic hydrocarbon group, except with part or all of carbon-carbon unsaturated bond(s) thereof being epoxidized.

2. The photosensitive composition for volume hologram recording according to claim 1, further comprising a sensitizing dye.

3. The photosensitive composition for volume hologram recording according to claim 1 or 2, further comprising at least one cationically polymerizable compound selected from the group consisting of:
epoxy compounds other than the alicyclic epoxy compound (A) and the epoxy compound (E);
oxetane compounds; and
vinyl ether compounds.

4. The photosensitive composition for volume hologram recording according to claim 1,
wherein the photosensitive comprises the epoxy compound (E) in a content from 50 to 500 parts by weight per 100 parts by weight of the total amount of cationically polymerizable compound(s) other than the epoxy compound (E).

5. A photosensitive composition for volume hologram recording obtained by a heat treatment of the photosensitive composition for volume hologram recording of claim 1 and comprising:
a three-dimensionally crosslinked polymer matrix comprising a cured product of cationically polymerizable compounds;
the radically polymerizable compound (C); and
the radical polymerization initiator (D).

6. A volume hologram recording medium comprising:
a first substrate;
a second substrate; and
a volume hologram recording layer between the first and second substrates, the layer comprising the photosensitive composition for volume hologram recording of claim 5.

7. The volume hologram recording medium according to claim 6,
wherein the volume hologram recording medium has a transmittance of 80% or more after recording and fixing of a hologram, the recording of the hologram performed by irradiating the volume hologram recording medium with a laser beam to polymerize the radically polymerizable compound (C) in the photosensitive composition for volume hologram recording.

8. A method for manufacturing a volume hologram recording medium, the method comprising the steps of:
holding the photosensitive composition for volume hologram recording of claim 1 between a first substrate and a second substrate to give a laminate; and
subjecting the laminate to a heat treatment.

9. A method for recording a hologram, comprising the step of irradiating the volume hologram recording medium of claim 6 or 7 with an active energy ray to polymerize the radically polymerizable compound (C) in the photosensitive composition for volume hologram recording.
